(19) United States
(12) Patent Application Publication
(10) Pub. No.: US 2005/0243445 A1
(43) Pub. Date: Nov. 3, 2005

(54) Boresight alignment hardware for commercial optical extension tubes

(76) Inventors: Dallas N. Barr, Woodbridge, VA (US); John E. Nettleton, Fairfax Station, VA (US)

Correspondence Address: DEPARTMENT OF THE ARMY, AMSEL LG P NVEO, 10225 BURBECK ROAD, FORT BELVOIR, VA, 22060-5806, US

(21) Appl. No.: 10/839,450

(22) Filed: Apr. 29, 2004

(51) Int. Cl. G02B 6/44

(52) U.S. Cl. 359/821

(57) ABSTRACT

An optical tube assembly set part that includes an optical tube section, a carrier smaller than the diameter of the optical tube section for carrying an optical component, hardware for holding the carrier within the optical tube section, and hardware for sliding the carrier to line up the optical center of the optical component with a predetermined optical axis.

### GOVERNMENT INTEREST

The invention described herein may be manufactured, used, sold, imported, and/or licensed by or for the Government of the United States of America.

### BACKGROUND OF THE INVENTION

This invention relates in general to optical devices, and more particularly, to optical prototyping hardware.

Optical tube assembly sets used to combine lenses, lasers and detectors are commonly available from optics vendors such as Thor Labs and Edmund Scientific. These sets consist of threaded one inch diameter, two inch diameter, C-mount and T-mount tubes, lens adapters, focusing rings and other compatible components. There are adapters available to hold various size components but the components can only be centered in the tube sections. This severely limits the ability of the prototype to be aligned and used with other components. The optical center of lenses, emitters and detectors is often much different than the physical center of the component housing and without an adjustment to correct for this error the optical axis cannot be controlled.

### SUMMARY OF THE INVENTION

It is therefore an object of this invention to enable bore sight (optical axis) adjustment of small elements in optical tube assembly sets.

This and other objects of the invention are achieved in one aspect by an optical tube assembly set part. The optical tube assembly set part includes an optical tube section, a carrier smaller than the diameter of the optical tube section for carrying an optical component, means for holding the carrier within the optical tube section, and means for sliding the carrier in the holding means to line up the optical center of the optical component with a predetermined optical axis.

Another aspect of the invention involves a method of combining optical components in an optical tube assembly set. The method includes the steps of providing an optical tube section, providing a carrier smaller than the diameter of the tube section for carrying an optical component, holding the carrier within the optical tube section, and sliding the carrier to line up the optical center of the optical component with a predetermined optical axis.

Currently all angular adjustments require the entire optical tube to be precisely tilted through the use of some external mounting fixture. The present invention is not only inherently inexpensive and compact but simplifies the design of any external mounts or holders by allowing them to be solid with no moving parts.

The present invention can be applied to any modular optical tube assembly in which there are two or more components and one of these is small compared to the inner diameter of the tube. Examples include an adjustable secondary lens for refractive telescopes, angular adjustment of collimated diode laser radiation, angular adjustment of the field of view of a detector at the focus of a lens and position adjustment of a reticle in a telescope or autocollimator.

Additional advantages and features will become apparent as the subject invention becomes better understood by reference to the following detailed description when considered in conjunction with the accompanying drawings wherein:

### BRIEF DESCRIPTION OF THE DRAWINGS

FIG. 1 is a schematic illustration of a first embodiment of the optical tube assembly set part in accordance with the invention.

FIG. 2 is a schematic illustration of a second embodiment of the optical tube assembly set part in accordance with the invention.

### DETAILED DESCRIPTION

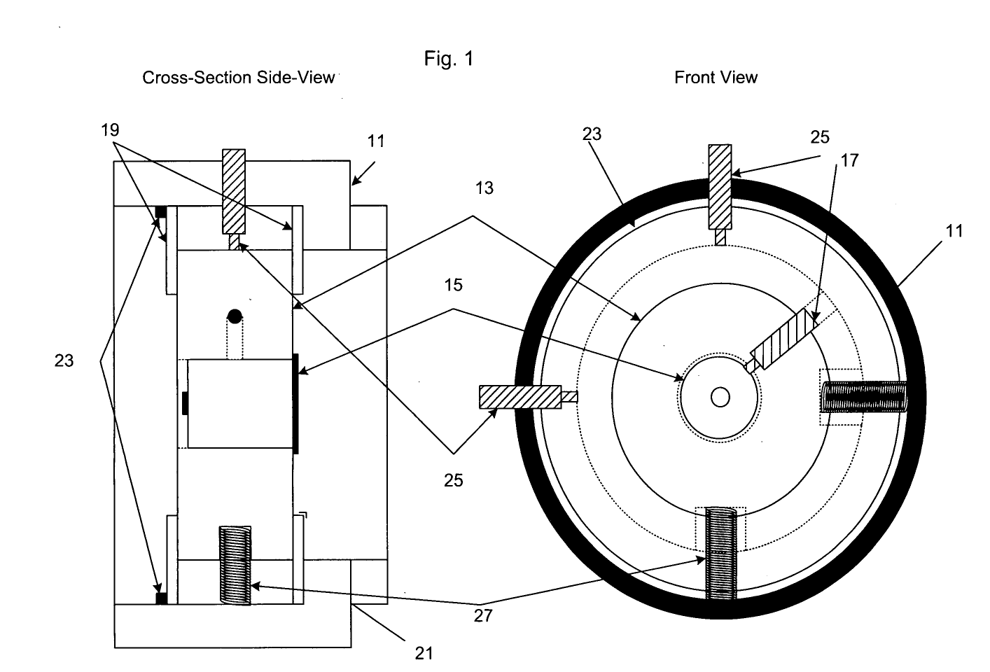

Referring to the Figures, wherein like reference numerals designate like or corresponding parts, and more particularly to FIG. 1, there is shown a first embodiment of the optical tube assembly set part. The optical tube assembly set part includes an optical tube section 11, such as a commercial optical tube section. Typical commercial optical tube sections come in lengths of 0.5, 1.0, 1.5 and 2.0 inches. Depending on the length of an optical component to be inserted in the optical tube section 11, any of these standard lengths may be used, although the 0.5 inch section is preferred. These tube sections are mass-produced and offer well-controlled tolerances so interchangeability of parts is assured.

The optical tube assembly set part also includes a carrier 13 for carrying a small optical component 15, such as a diode laser, a detector or a telescope secondary lens, for example. The carrier 13 is smaller than the inner diameter of the optical tube section 11. The material of the carrier 13 may be metal, plastic or ceramic with the choice being influenced by cost, thermal properties, and ease of machining.

The optical component 15 is mounted in the center of the carrier 13 and is held in place by a setscrew 17. The carrier 13 can be predrilled for standard components or it can be delivered to the user with only a small pilot hole for the user to use to center drill to any size for non-standard components.

The optical tube assembly set part also includes a means for holding the carrier 13 within the optical tube section 11. While the holding means may take a variety of forms, conveniently it may take the form shown in the figures of a pair of spaced washers 19, a step 21 in the wall of the optical tube section against which one of the washers 19 rests, and a threaded retainer ring 23 against which the other washer rests. The washers can be formed from any material that is compatible with the carrier 13. A Belleville Spring washer (not shown) can be employed in place of the threaded retainer ring 23 to reduce the tolerance requirements.

The pair of spaced washers 19 is disposed inside the optical tube section 11 in such a manner that when the carrier 13 is initially inserted between them and their grip is relaxed by loosening the threaded retainer ring 23 which presses the washers against the step 21, the carrier can move in a plane perpendicular to the predetermined optical axis along which it is desired to align the optical component 15.

Lastly, the optical tube assembly set part includes a means for sliding the carrier 13 in the holding means to line up the optical center of the optical component 15 with the predetermined optical axis. While the sliding means may take a variety of forms, conveniently it may take the form shown in the figures of a pair of spring-biased plastic-tipped setscrews 25 passing through the wall of the optical tube section 11 and against flat spots on one side of the carrier 13. The setscrews 25 are positioned 90 degrees apart. For fine adjustments, the thread count of the setscrews should be as fine as possible.

In the FIG. 1 embodiment, the spring-biasing is provided by a pair of springs 27 disposed between recesses in the opposite side of the carrier 13 and the wall of the optical tube section 11. The springs 27 are aligned along the axes of the setscrews 25 and oppose the motion of the carrier 13 caused by tightening the setscrews.

In operation, the threaded retainer ring 23 is loosened to relax the pressure of the washers 19 on the carrier 13 to permit the carrier to move. Next, the setscrews 25 are tightened or loosened to cause the carrier 13 to slide at right angles to the predetermined optical axis until the optical center of the optical component 15 is lined up with the optical axis. The flat spots on the carrier 13 where the setscrews 25 contact it are provided so that the carrier 13 can slide in one direction without moving in the other direction. The springs 27 are able to sway the amount necessary to maintain the orthogonal motion of the two adjustments. When the adjustments are completed, the threaded retainer ring 23 is tightened to increase the pressure of the washers on the carrier 13 and to fix the carrier in place.

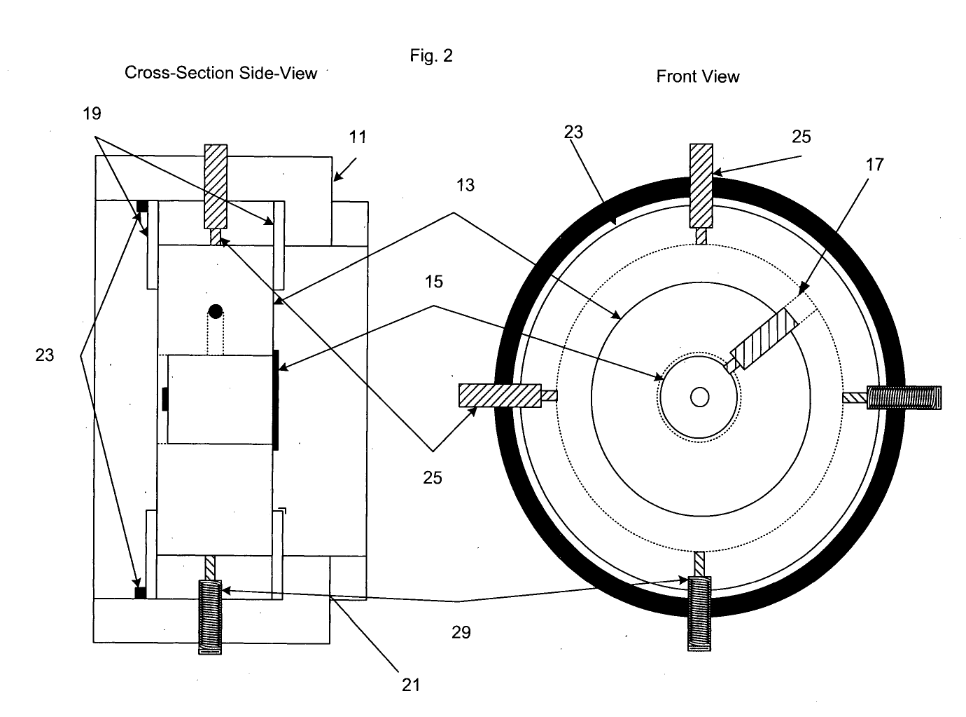

FIG. 2 shows a second embodiment, which differs from the first embodiment, in that the spring-biasing is provided by Delrin-tipped spring-loaded plungers 29, such as commercial plungers, passing through the wall of the optical tube section 11 and against the opposite side of the carrier 13 from the setscrews. The plungers 29 are aligned along the axes of the setscrews 25 and oppose the motion of the carrier 13 caused by tightening the setscrews. The advantage of this approach is ease of assembly as the springs are already contained in a convenient and adjustable setscrew like package. In addition, a greater range of adjustment may be available since the effective length of the spring and the spring loading can be adjusted by moving the plunger housing.

In conclusion, an inexpensive device has been described to significantly enhance the functionality of currently available commercial optical prototyping hardware.

It is obvious that many modifications and variations of the present invention are possible in light of the above teachings. It is therefore to be understood that within the scope of the appended claims, the invention may be practiced otherwise than as described.

1. An optical tube assembly set part comprising:
an optical tube section;
a carrier smaller than the diameter of the optical tube section for carrying an optical component;
means for holding the carrier within the optical tube section; and
means for sliding the carrier in the holding means to line up the optical center of the optical component with a predetermined optical axis.

2. The optical tube assembly set part recited in claim 1 in combination with an optical component.

3. The optical tube assembly set part recited in claim 1 wherein the holding means includes:
A pair of spaced washers disposed inside the optical tube section.

4. The optical tube assembly set part recited in claim 3 wherein the holding means includes:
a step in the wall of the optical tube section against which one of the washers rests.

5. The optical tube assembly set part recited in claim 4 wherein the holding means includes:
a threaded retainer ring against which the other washer rests.

6. The optical tube assembly set part recited in claim 1 wherein the sliding means includes:
a setscrew passing through the wall of the optical tube section and against a flat spot on one side of the carrier.

7. The optical tube assembly set part recited in claim 6 wherein the sliding means includes:
a spring disposed between a recess in the opposite side of the carrier and the wall of the optical tube section.

8. The optical tube assembly set part recited in claim 6 wherein the sliding means includes:
a spring-loaded plunger passing through the wall of the optical tube section and against the opposite side of the carrier.

9. The optical tube assembly set part recited in claim 1 wherein:
the carrier is a plastic carrier.

10. The optical tube assembly set recited in claim 1 wherein:
the carrier is a metal carrier.

11. The optical tube assembly set recited in claim 1 wherein:
the carrier is a ceramic carrier.

12. An optical tube assembly set part comprising:
an optical tube section having a stepped wall;
a carrier smaller than the diameter of the optical tube section for carrying an optical component;
a pair of spaced washers disposed inside the optical tube section and holding the carrier within the optical tube section;
a threaded retainer ring disposed inside the optical tube section;
one of the washers resting against the step in the wall of the optical tube section, the other washer resting against the threaded retainer ring; and
a pair of 90 degree spaced-apart spring-biased setscrews passing through the wall of the optical tube section and against a flat spot on one side of the carrier for sliding the carrier to line up the optical component with a predetermined optical axis.

13. The optical tube assembly set part recited in claim 12 in combination with an optical component.

14. A method of combining optical components in an optical tube assembly set comprising the steps of:
providing an optical tube section;
providing a carrier smaller than the diameter of the tube section for carrying an optical component;
holding the carrier within the optical tube section; and
sliding the carrier to line up the optical center of the optical component with a predetermined optical axis.

15. The method recited in claim 14 wherein the holding step includes:
disposing a pair of spaced washers inside the optical tube section.

16. The method recited in claim 15 wherein the holding step includes:
resting one of the washers against a step in the wall of the optical tube section.

17. The method recited in claim 16 wherein the holding step includes:
resting the other washer against a threaded retainer ring.

18. The method recited in claim 14 wherein the sliding step includes:
passing a setscrew through the wall of the optical tube section and against a flat spot on one side of the carrier.

19. The method recited in claim 18 wherein the sliding step includes:
disposing a spring between a recess in the opposite side of the carrier and the wall of the optical tube section.

20. The method recited in claim 19 wherein the sliding step includes:
passing a spring-loaded plunger through the wall of the optical tube section and against the opposite side of the carrier.
